(19) United States
(12) Patent Application Publication
(10) Pub. No.: US 2010/0081836 A1
(43) Pub. Date: Apr. 1, 2010

(54) PROCESS FOR EXTRACTING A TARGET COMPOUND USING HFO1234yf

(76) Inventors: Laurence Parslow, Marrtensville (CA); Peter Frederick Wilde, North Yorkshire (GB)

Correspondence Address: KOPPEL, PATRICK, HEYBL & DAWSON, 2815 Townsgate Road, SUITE 215, Westlake Village, CA, 91361-5827, US

(21) Appl. No.: 12/567,614

(22) Filed: Sep. 25, 2009

Related U.S. Application Data
(60) Provisional application No. 61/100,558, filed on Sep. 26, 2008.
(60) Provisional application No. 61/140,322, filed on Dec. 23, 2008.

(51) Int. Cl. C11B 1/10

(52) U.S. Cl. 554/13; 554/21

(57) ABSTRACT

A process for selectively extracting a target compound from a raw material using 2,3,3,3-tetrafluoropropene (HFO1234yf) as the extraction solvent, and optionally at least one co-solvent, comprising contacting the raw material with the HFO1234yf at a first temperature forming a HFO1234yf solution, and subsequently cooling the HFO1234yf solution. In particular, the application relates to a process for extracting fragrance oils, flavor oils, pharmaceutical agents, fixed oils and/or mineral oils.

### PRIORITY INFORMATION

This application claims the benefit of U.S. Provisional Application Nos. 61/100,558 and 61/140,322 filed on Sep. 26, 2008 and Dec. 23, 2008, respectively, and entitled PROCESS FOR EXTRACTING A TARGET COMPOUND USING HFO1234YF, the contents of which of which are expressly incorporated herein by reference.

### FIELD OF THE APPLICATION

This application relates to a process for selectively extracting a lipophilic target compound. In particular, the application relates to a process for extracting fragrance oils, flavor oils, pharmaceutical agents, fixed oils and/or mineral oils.

### BACKGROUND

Extraction of a target compound using an extraction solvent typically results in a solution of the target compound dissolved in the solvent. To separate the target compound from the extraction solvent, it is generally necessary to heat the solution to evaporate the solvent, leaving the pure target compound. Unfortunately, heating the solution often destroys fragile compounds, such as pharmaceutical agents or proteins and may cause the evaporation of the light components of a fine fragrance or flavor ingredients.

### SUMMARY

The application relates to a process for the selective extraction of a lipophilic target compound from an oil-bearing raw material using the solvent 2,3,3,3-tetrafluoropropene (HFO1234yf), optionally in admixture with at least one co-solvent. In particular, the application relates to a process for extracting fragrance oils, flavor oils, pharmaceutical agents, fixed oils and/or mineral oils.

Accordingly, the application provides a process for the selective extraction of lipophilic target compounds of low molecular weight, such as volatile oils, pharmaceutical agents, fragrance oils and flavor oils, using HFO1234yf, optionally in admixture with at least one co-solvent, at a temperature of about 15° C. to about 25° C., optionally about 18° C. to about 22° C. The HFO1234yf, and optionally the at least one co-solvent, is simply evaporated at temperature of about 30° C. to obtain the purified low molecular weight target compound.

In another embodiment, the target compound has a molecular weight between about 0 to about 650 g/mol and a boiling point between about 30° C. to about 300° C.

In a further embodiment, the target compound comprises a fragrance oil, a flavor oil and/or a pharmaceutical agent and the raw material comprises a plant raw material, an animal raw material and/or mineral raw material.

In another embodiment, the co-solvent comprises an alkane, an alkene, a fluorinated alkane or a fluorinated alkene. In a further embodiment, the alkane, alkene, fluorinated alkane or fluorinated alkene comprises butane, propane, propylene, butylene (α, β [cis and trans] and iso-), pentane (n- and iso- and cyclo-), a proprietary mixture of 1,1,1,3,3-pentafluoropropane (HFC245fa) and 1,1,1,2,2,3,4,5,5,5-decafluoropentane (the mixture abbreviated as HFC365HX); 1,1,1,2,2,3,4,5,5,5-decafluoropentane (HFC 43 10mee); or 1,1,1,2,2-pentafluoroethane (HFC 125).

In another embodiment, the co-solvent comprises about 5% to about 50% by volume of the solvent mixture. In another embodiment, the co-solvent comprises about 15% to about 25% by volume of the solvent mixture. In another embodiment, the co-solvent comprises about 20% by volume of the solvent mixture.

The application also provides a process for the extraction of target compounds possessing a higher molecular weight and that are substantially in-volatile, to be extracted from raw materials such as roots, bark, leaves, nuts, oilseeds, palm kernel oil wastes, mineral oil shales or tar sands. In a further embodiment, the raw material is canola, rapeseed, crambe, soybean, mustard seed, camelina, vernonia, borage, echium, hemp seed, flax/linseed, cotton seed, jatropha, saw palmetto berries, peanut, groundnut, oats, barley, marigold flowers and tomato skins, a carotenoid-containing feed stock, algae, micro algae, fungi, micro fungi, marine fungi, krill or other oil containing shellfish and their waste shells. In this embodiment of the disclosure, HFO1234yf and optionally at least one co-solvent are heated to extract the target compounds of higher molecular weight. This process allows for the extraction of lipophilic target compounds such as fixed and/or mineral oils. The oil is thereafter separated from the HFO1234yf by simply cooling the solution to about 30° C., optionally to about 20° C., optionally about 15° C.

Accordingly, the application provides a process for the extraction of a target compound from a raw material comprising contacting the raw material with HFO1234yf, and optionally at least one co-solvent, at an elevated temperature, to extract the target compound.

In another embodiment, the temperature of the solvent mixture is raised to about 50° C. to about 70° C., optionally about 60° C.

In another embodiment, the target compound has a molecular weight between about 0 and about 3,000 g/mol. In another embodiment, the target compounds extracted at an elevated temperature are substantially in-volatile.

In another embodiment, when the extraction is performed at an elevated temperature, the target compound comprises a fixed oil or a mineral oil.

In another embodiment, the process further comprises separating the target compound from the HFO1234yf.

In another embodiment, the process further comprises cooling the solution of the target compound to precipitate the target compound from the solution of the target compound and the HFO1234yf.

In another embodiment, the process further comprises, after the cooling step, of separating the precipitated target compound from the depleted solution by decantation. In an embodiment, the target compound floats (supernatant) on the depleted solvent (infranatant).

In another embodiment, the process further comprises, after the separation of the target compound, of re-heating the decanted depleted solvent by passing it through a heat exchanger prior to recycling the extraction solvent.

In another embodiment, the application also includes a process for the selective extraction of a target compound from a raw material comprising:
(i) contacting the raw material with HFO1234yf (2,3,3,3-tetra fluoro prop-ene) at a first temperature to extract the target compound into the HFO1234yf thereby forming a HFO1234yf solution, and
(ii) cooling the HFO1234yf solution to a second temperature to separate the target compound from the HFO1234yf.

In an embodiment, the process further comprises a co-solvent comprising an alkane, alkene, fluorinated alkane or fluorinated alkene. In a further embodiment, the alkane or alkene comprises butane, propane, propylene, butylene (α, β [cis and trans] and iso-), n-pentane, iso-pentane or cyclopentane. In an embodiment, the fluorinated alkane or fluorinated alkene comprises a proprietary mixture of 1,1,1,3,3-pentafluoropropane (HFC245fa) and 1,1,1,2,2,3,4,5,5,5-decafluoropentane (the mixture abbreviated as HFC365HX); 1,1,1,2,2,3,4,5,5,5-decafluoropentane (HFC 43 10mee); or 1,1,1,2,2-pentafluoroethane (HFC 125).

In another embodiment, the co-solvent comprises about 5% to about 50% by volume, optionally about 15% to about 25% by volume, optionally about 20% by volume.

In another embodiment, the first temperature is between about 50° C. to about 70° C. In a further embodiment, the first temperature is about 60° C. In another embodiment, the second temperature is less than about 30° C., optionally less than about 20° C., optionally less than about 15° C. In another embodiment, the second temperature is between about 0° C. to about 30° C.

In another embodiment, the target compound is substantially in-volatile. In another embodiment, the target compound has a molecular weight of about 0 to about 3000 g/mol. In a further embodiment, the target compound comprises a fixed oil or a mineral oil.

In a further embodiment, the raw material comprises a plant raw material, an animal raw material or a mineral raw material. In another embodiment, the raw material comprises roots, bark, leaves, nuts, oilseeds, palm kernel oil wastes, mineral oil shales or tar sands. In an embodiment, the raw material comprises canola, rapeseed, crambe, soybean, all mustard seeds, camelina, vernonia, borage, echium, hemp seed, flax/linseed, cotton seed, jatropha, saw palmetto berries, peanut, groundnut, oats, barley, marigold flowers and tomato skins, a carotenoid-containing feed stock, algae, micro algae, fungi, micro fungi, marine fungi, krill or other oil containing shellfish and their waste shells.

In another embodiment, the process further comprises cooling the HFO1234yf solution to precipitate the target compound from the solution, resulting in cold depleted HFO1234yf and the at least one-cosolvent, to be decanted for re-cycling and re-use. In another embodiment, further comprising, after the cooling step, separating the precipitated target compound from the thereby depleted HFO1234yf solution.

In an embodiment, the process further comprises, after the separating step, heating the HFO1234yf and at least one co-solvent.

In another embodiment, the extracted raw material is a proteinaceous meal. In a further embodiment, the proteinaceous meal is substantially non-denatured.

In another embodiment, the disclosure also includes the use of HFO1234yf, and at least one co-solvent, for extracting a fragrance oil, flavor oil, pharmaceutical agent, fixed oil and/or mineral oil from a plant raw material, animal raw material or mineral raw material.

The disclosure also includes a composition comprising HFO1234yf and at least one co-solvent.

In another embodiment, the alkane or alkene comprises butane, propane, propylene, butylene (α, β [cis and trans] and iso-), pentane (n- and iso- and cyclo-), a fluorinated alkane or a fluorinated alkene, a proprietary mixture of 1,1,1,3,3-pentafluoropropane (HFC245fa) and 1,1,1,2,2,3,4,5,5,5-decafluoropentane (the mixture abbreviated as HFC365HX); 1,1,1,2,2,3,4,5,5,5-decafluoropentane (HFC 43 10mee); or 1,1,1,2,2-pentafluoroethane (HFC 125).

In a further embodiment, the composition is used for extracting a fragrance oil, flavor oil, pharmaceutical agent, fixed oil and/oil mineral oil from a plant raw material, animal raw material or mineral raw material.

The application also includes a process for the selective extraction of a target compound from a raw material comprising:
(i) contacting the raw material with a solvent at a first temperature to extract the target compound into the solvent thereby forming a solution, wherein the solvent is a tetrafluoropropene, a pentafluoropropene, or a mixture thereof, and
(ii) cooling the solution to a second temperature to separate the target compound from the solvent.

In another embodiment, the tetrafluoropropene is HFO1234yf or cis- or trans-1,3,3,3-tetrafluoropropene (HFO1234ze). In another embodiment, the pentafluoropropene is 1,1,1,2,3-pentafluoropropene (R1225ye).

In an embodiment, the process further comprises a co-solvent comprising an alkane, alkene, fluorinated alkane or fluorinated alkene. In a further embodiment, the alkane or alkene comprises butane, propane, propylene, butylene (α, β [cis and trans] and iso-), n-pentane, iso-pentane or cyclopentane. In an embodiment, the fluorinated alkane or fluorinated alkene comprises a proprietary mixture of 1,1,1,3,3-pentafluoropropane (HFC245fa) and 1,1,1,2,2,3,4,5,5,5-decafluoropentane (the mixture abbreviated as HFC365HX); 1,1,1,2,2,3,4,5,5,5-decafluoropentane (HFC 43 10mee); or 1,1,1,2,2-pentafluoroethane (HFC 125).

In another embodiment, the co-solvent comprises about 5% to about 50% by volume, optionally about 15% to about 25% by volume, optionally about 20% by volume.

In another embodiment, the first temperature is between about 50° C. to about 70° C. In a further embodiment, the first temperature is about 60° C. In another embodiment, the second temperature is less than about 30° C., optionally less than about 20° C., optionally less than about 15° C. In another embodiment, the second temperature is between about 0° C. to about 30° C.

In another embodiment, the target compound is substantially in-volatile. In another embodiment, the target compound has a molecular weight of about 0 to about 3000 g/mol. In a further embodiment, the target compound comprises a fixed oil or a mineral oil.

In a further embodiment, the raw material comprises a plant raw material, an animal raw material or a mineral raw material. In another embodiment, the raw material comprises roots, bark, leaves, nuts, oilseeds, palm kernel oil wastes, mineral oil shales or tar sands. In an embodiment, the raw material comprises canola, rapeseed, crambe, soybean, all mustard seeds, camelina, vernonia, borage, echium, hemp seed, flax/linseed, cotton seed, jatropha, saw palmetto berries, peanut, groundnut, oats, barley, marigold flowers and tomato skins, a carotenoid-containing feed stock, algae, micro algae, fungi, micro fungi, marine fungi, krill or other oil containing shellfish and their waste shells.

### DETAILED DESCRIPTION

The present application describes a process for the selective extraction of a lipophilic target compound from an oil-bearing raw material using the solvent HFO1234yf, and optionally at least one co-solvent. In particular, the application relates to a process for extracting fragrance oils, flavor oils, pharmaceutical agents, fixed oils and/or mineral oils using carefully defined solvent mixtures (cocktails) and carefully defined temperatures. In another embodiment, the HFO1234yf is used alone as the extraction solvent.

It will be known to those skilled in the art that HFO1234yf is frequently used as a refrigerant because of its extremely low Global Warming Potential (GWP) of 4.0. At the same time, HFO1234yf is typically a very poor solvent because of its low ability, at low temperatures, to dissolve lipophilic compounds. It has now been determined that when HFO1234yf is optionally combined with other co-solvents, or heated to an elevated temperature, the solvent becomes an excellent solvent for the extraction of lipophilic target compounds from oil-bearing raw materials. Further, the extremely low boiling point of HFO1234yf (approximately −30° C.) results in the facile separation of the solvent mixture from the target compound. In general, the solvent mixture with dissolved target compound need only be brought to about 15° C. to about 25° C., optionally about 18° C. to about 22° C., and standard pressure for the solvent mixture to evaporate, leaving the purified target compound.

Accordingly, the present disclosure provides a process for the selective extraction of lipophilic target compounds of low molecular weight, such as volatile oils, pharmaceutical agents, fragrance oils and flavor oils, using HFO1234yf, and optionally at least one co-solvent, as the extraction solvent at a temperature of about 15° C. to about 25° C., optionally about 18° C. to about 22° C. The HFO1234yf and optionally the at least one co-solvent is thereafter simply evaporated, at a temperature of about 30° C. to obtain the purified low molecular weight target compound.

In an embodiment, the low molecular weight target compounds such as the volatile oils include flower oils (fine fragrance oils) from roses, frangipani, jasmine, ylang-ylang, tuberose and orange blossom; flavor oils including coffee oil, vanilla oil, vanillin, piperine, capsaicin, black pepper oil, esters and aldehydes; and pharmaceutical agents and antibiotics including, artemisinine, leutein, astaxanthin, cytochalaisin, monensin and pencillin terpenes, caffeine and pyrethryn.

In an embodiment, the molecular weight of the low molecular weight compounds is from about 0 to about 650 g/mol. In another embodiment, the target compounds possess boiling points of about 30° C. to about 300° C.

The present disclosure also provides a process for the extraction of target compounds possessing a higher molecular weight and which are substantially in-volatile. In an embodiment, the oil-bearing raw materials include roots, bark, leaves, nuts, oil-seeds (such as palm kernel oil waste, maize, soya, canola, rape seed, almonds, hazel nuts, sunflower seed, flax seed, jetropha etc.), mineral oil shales or tar sands. Further included as the target compound are triglycerides, fatty acids, terpenes, hydrocarbons, aldehydes, resins, esters, waxes and sesquiterpenes. In this embodiment, the lipophilic target compounds include fixed and/or mineral oils. In a further embodiment, the target compounds of higher molecular weight also include vetiver root, cinnamon bark, massoiya bark, sandal wood oil, agar wood oil and ginger oil.

In an embodiment, the process of the present disclosure provides a process for the selective extraction of a target compound. It will be understood by a person skilled in the art that if a fixed and/or mineral oil is the target compound, a pre-extraction step will be performed to remove lipophilic compounds of low molecular weight, such as volatile oils, pharmaceutical agents, fragrance oils and flavor oils. The extraction process of the present disclosure is performed to obtain the target compound from the pre-extracted raw material.

In an embodiment of the disclosure, HFO1234yf, and optionally at least one co-solvent, are heated to a first temperature to extract the lipophilic target compounds of higher molecular weight. In this embodiment, the target compound, such as an oil, is separated from the solvent by simply cooling the solution to a second temperature, optionally a temperature below about 30° C., optionally below about 20° C., optionally below about 15° C. so that the target compound precipitates from solution and separates from the solvent and floats on the solvent. In a further embodiment, the thus depleted solvent is thereafter recovered by decantation and is used for further extractions.

In an embodiment, the molecular weight of the high molecular weight compounds is from about 0 to about 3000 g/mol. In another embodiment, the target compounds are substantially in-volatile.

It will be understood by those skilled in the art that the solvent comprising HFO1234yf and optionally at least one co-solvent, are able to dissolve higher molecular weight compounds, such as fixed and/or mineral oils, at elevated temperatures, such as between about 50° C. to about 70° C., because of the dissolving power of the HFO1234yf at elevated temperatures or the optional at least one-co-solvent. When the temperature of the solvent containing the dissolved target compound is reduced to a temperature below about 30° C., optionally below about 20° C., optionally below about 15° C., optionally between about 0° C. to about 30° C., the target compound precipitates from the solvent as a result of the HFO1234yf being an extremely poor solvent at that temperature.

Also included within the scope of the present disclosure is a proteinaceous meal produced from oil seeds and grains, which in an embodiment comprise the raw material. In accordance with the process of the present disclosure, the proteinaceous meal comprises the spent residual raw material from the extraction process, when the raw material is an oil seed or a grain such as canola, soya, ground nuts, rape seed, palm kernels, maize, rape seed, almonds, hazel nuts, sunflower seed, flax seed, jetropha etc. In another embodiment, the raw material comprises all mustard seeds, such as and including brassica juncea. In an embodiment, the spent raw materials contain proteins, suitable for use as food-stuffs. In an embodiment, the spent raw material contains protein derived from canola seed or brassica juncea as the raw material. In a further embodiment, when the raw material comprises canola seed, the spent raw material comprises a proteinaceous meal containing 43-45% protein on a dry weight basis (dwb). In a further embodiment, when the raw material comprises brassica juncea, the spent raw material comprises a proteinaceous meal containing 48-50% protein on a dry weight basis (dwb).

Before being subject to the extraction process of the present disclosure, the raw material is optionally pre-treated. In an embodiment of the disclosure, raw material is subjected to a cold-pressing pre-treatment in which pressing removes a portion of the desired fixed oil target compound. In another embodiment, the raw material is subjected to a grinding pre-treatment in which there is no extraction of the desired target compound.

Accordingly, the present disclosure provides a process for the extraction of a lipophilic target compound from an oil-bearing raw material comprising contacting the raw material with HFO1234yf, and optionally at least one co-solvent, to extract the target compound.

In an embodiment, the molecular weight of the low molecular weight compounds is from about 0 to about 650 g/mol. In another embodiment, the target compounds possess boiling points of about 30° C. to about 300° C.

In another embodiment, when the target compound is a low molecular weight compound, the temperature of the solvent is about 15° C. to about 25° C., optionally about 18° C. to about 22° C.

In a further embodiment, the optional co-solvent comprises an alkane, alkene, a fluorinated alkane or a fluorinated alkene including butane, propane, propylene, butylene (α, β [cis and trans] and iso-), pentane (n- and iso- and cyclo-), HFC 365HX (mixture of HFC 245fa [1,1,1,3,3-penta fluoro propane] and HFC 43 10mee), HFC 43 10mee [1,1,1,2,2,3,4,5,5,5-deca fluoro pentane] or HFC 125 [1,1,1,2,2-penta fluoro ethane].

In another embodiment, the co-solvent comprises about 5% to about 50% by volume of the solvent mixture. In another embodiment, the co-solvent comprises about 15% to about 25% by volume of the solvent mixture. In another embodiment, the co-solvent comprises about 20% by volume of the solvent mixture.

In an embodiment, when a co-solvent is also used in an extraction at a first temperature, the target compound will have a higher solubility in the co-solvent than compared to the HFO1234yf. Accordingly, in an embodiment, it will be understood by those skilled in the art that by carefully controlling the volumes of the HFO1234yf and the optional co-solvent, extractions can be performed on a variety of raw materials. In an embodiment, the choice of co-solvent and the volume used will depend on the solubility of the target compound. In an embodiment, when the extraction is performed at a first temperature, the optional co-solvent aids in solubilizing the target compound into the solvent mixture. In a further embodiment, as the HFO1234yf solution (and optional co-solvent) are cooled to a second temperature, the target compound precipitates from the HFO1234yf as a result of the target compound being less soluble in the HFO1234yf at the second temperature.

It will be understood by those skilled in the art that by controlling the temperature of the extraction, a target compound is selectively extracted from the oil-bearing raw material. For example, if a fine fragrance or other volatile oil is desired, this type of target compound is extracted by maintaining the temperature of the extraction at a temperature of about 15° C. to about 25° C., optionally about 18° C. to about 22° C. If a fixed oil or mineral oil is desired, from a raw material such as an oil seed, a preliminary extraction is performed to remove any volatile oils that may not be desired. A further extraction is then performed with the solvent mixture at an elevated temperature to extract the fixed oil or mineral oil.

Accordingly, in another embodiment, to extract fixed and/or mineral oils (target compounds having a higher molecular weight), the temperature of the solvent mixture during the extraction is maintained at a first temperature, optionally an elevated temperature of about 50° C. to about 70° C., optionally about 60° C., thereby forming a HFO1234yf solution. However, this elevated temperature preserves the desirable spent proteinaceous residual raw-material for use as a valuable food stuff, without damaging or de-naturing the protein.

In another embodiment, the process further comprises separating the target compound from the solvent mixture. In an embodiment, when the extraction is performed at a temperature of about 15° C. to about 25° C., optionally about 18° C. to about 22° C. to extract low molecular weight target compounds, the solvent mixture is evaporated by providing enough heat to the solution to evaporate the solvent mixture. In an embodiment, the solution is warmed to about 30° C. to evaporate the solvent leaving the purified target compound.

In another embodiment, when the extraction is carried out at an elevated temperature, the process further comprises cooling the HFO1234yf solution to a second temperature to precipitate the target compound from the HFO1234yf. As a result of the cooling of the solution to the second temperature, the target compound precipitates (and generally floats) from the HFO1234yf, and optionally the at least one co-solvent. In an embodiment, the HFO1234yf solution is reduced to a temperature below about 30° C., optionally below about 20° C., optionally below about 15° C. In another embodiment, the second temperature is between about 0° C. to about 30° C.

In another embodiment, the process further comprises, after cooling the HFO1234yf solution, separating the precipitated target compound from the HFO1234yf solution, whereby a depleted solvent is formed. In a further embodiment, the depleted solvent is recycled for further use as an extraction solvent. In another embodiment, the depleted solvent is heated to evaporate the solvent and condensed to be recycled for further use as an extraction solvent.

In another embodiment, the process further comprises, after separation of the target compound from the HFO1234yf, heating the solvent and subsequently condensing it so it is recycled for further use.

In another embodiment of the present disclosure, there is described a process for the selective extraction of a target compound from a raw material comprising contacting the raw material with HFO1234yf, to extract the target compound. In this embodiment, the HFO1234yf is able to extract target compounds such as fragrance oils, flavor oils or flower oils. In an embodiment, the target compounds possess a low molecular weight of about 0 to about 350 g/mol, and have a boiling point of about 30° C. to about 150° C. In another embodiment, the target compound is rose oil, frangipani oil, jasmine oil, ylang-ylang oil, tuberose oil, orange blossom oil, black pepper oil, esters or aldehydes. In another embodiment, the extraction using HFO1234yf alone is performed at a temperature of about 15° C. to about 70° C., optionally at 17° C. or about 50 to about 60° C.

In another embodiment, the disclosure also includes the use of HFO1234yf, and optionally at least one co-solvent, for extracting a fragrance oil, flavor oil, pharmaceutical agent, fixed oil and/oil mineral oil from a plant raw material, animal raw material or mineral raw material.

The disclosure also includes a composition comprising HFO1234yf and at least one co-solvent.

In another embodiment, the co-solvent comprises an alkane, alkene, fluorinated alkane or fluorinated alkene including butane, propane, propylene, butylene (α, β [cis and trans] and iso-), pentane (n- and iso- and cyclo-), HFC 365HX (mixture of HFC 245fa [1,1,1,3,3-penta fluoro propane] and HFC 43 10mee), HFC 43 10mee [1,1,1,2,2,3,4,5,5,5-deca fluoro pentane] or HFC 125 [1,1,1,2,2-penta fluoro ethane].

In another embodiment of the disclosure, the extraction process is carried out by sufficiently mixing HFO1234yf, and optionally at least one co-solvent, with the raw material in an extractor to form a slurry, wherein the target compound is selectively extracted into the HFO1234yf and optionally at least one co-solvent. The HFO1234yf, and optionally at least one co-solvent, and the dissolved target compound is then transferred to an evaporator via a filter leaving behind the spent raw material. The HFO1234yf, and optionally at least one co-solvent, is then evaporated from the evaporator leaving the selected purified target compound. The evaporated HFO1234yf, and optionally at least one co-solvent, is re-condensed and recovered from both the target compound and the spent raw material and recycled for further use as the extraction solvent. In operation, the extraction and evaporation process is performed in a closed-loop, sealed system, such as a continuous counter-current extractor, as described U.S. patent application Ser. No. 12/199,451, herein incorporated by reference. In another embodiment, the extraction is repeated on the spent raw material to increase the yield of the extraction process for example, by counter current extraction.

In another embodiment, when the target compound possesses a higher molecular weight, HFO1234yf and the at least one co-solvent are sufficiently mixed with the raw material in an extractor at a first temperature of about 50° C. to about 70° C., optionally about 60° C., to form a slurry, wherein the target compound is extracted from the raw material. In another embodiment, the extraction process is carried out at an elevated first temperature by increasing the temperature of the extractor or by passing the solvent through a heat-exchanger into an insulated extractor (otherwise un-heated). The solvent mixture and the dissolved target compound is then transferred to an evaporator via a filter leaving behind spent raw material. The solvent mixture is evaporated from the evaporator leaving behind the purified target compound. The evaporated solvent mixture is typically recovered and recycled for further use as the extraction solvent. In operation, the extraction and evaporation process is performed in a closed-loop, sealed system, such as a continuous counter-current extractor, as described U.S. patent application Ser. No. 12/199,451, herein incorporated by reference. In another embodiment, the extraction is repeated on the spent raw material to increase the yield of the extraction process, for example, using continuous counter current extraction.

In another embodiment of the disclosure, when the raw material is an oil seed or a grain, the spent raw material is then subjected to an evaporative process to remove residual extraction solvent, resulting in a purified protein meal useful as a food-stuff.

Terms of degree such as “substantially”, “about” and “approximately” as used herein mean a reasonable amount of deviation of the modified term such that the end result is not significantly changed. These terms of degree should be construed as including a deviation of at least ±10% of the modified term if this deviation would not negate the meaning of the word it modifies.

Certain embodiments of the invention are disclosed below by way of example:

### Example 1

### Butane as Solvent for Flax Seed Extraction

Commercially available ground flax seed containing 34% oil (w/w) was extracted using 100% liquid butane, as solvent. 40 grams of flax seed (containing approximately 13.6 grams of oil) were shaken with 40 grams of liquid butane. The slurry so formed was filtered and yielded a clear yellow solution weighing 34.20 grams.

### Example 2

### HFO1234yf with Butane as Co-Solvent for Flax Seed Extraction

To this solution from Example 1 was added, incrementally, sequentially and at room temperature (17° C.), the following quantities of HFO1234yf:

| QUANTITY | AGGREGATE | % HFO w/w | SOLUTION |
|---|---|---|---|
| of HFO | ADDITION | in solution | APPEARANCE |
| 30 grams | 30 grams | 46.73% | CRYSTAL CLEAR |
| 29 grams | 59 grams | 63.30% | CRYSTAL CLEAR |
| 15 grams | 74 grams | 68.4% | HAZY SOLUTION |
| 19.7 grams | 93.7 grams | 73.3% | CLOUDY |
| 17 grams | 110.7 grams | 76.4% | OIL SETTLES OUT |

Subsequent to concluding this experiment, the solvent was entirely removed from the oil. The bottle was weighed again and the contents were found to actually contain 5.62 grams of oil. The original mixture in this bottle, therefore, actually comprised 28.58 grams of butane (34.20-5.62).

A revision to the above figures must therefore be calculated as follows:

| | | Composition of mixture | | |
|---|---|---|---|---|
| QUANTITY | AGGREGATE | in solution | | SOLUTION |
| of HFO | ADDITION | HFO 1234yf | BUTANE | APPEARANCE |
| 30 grams | 30 grams | 51.20% | 48.80% | CRYSTAL CLEAR |
| 29 grams | 59 grams | 67.37% | 32.63% | CRYSTAL CLEAR |
| 15 grams | 74 grams | 72.14% | 27.86% | HAZY SOLUTION |
| 19.7 grams | 93.7 grams | 76.63% | 23.37% | CLOUDY |
| 17 grams | 110.7 grams | 79.48% | 20.52% | OIL SETTLES OUT |

The HFO1234yf added to the butane solution from Example 1, results in significantly more target compound precipitating from the solvent mixture.

### Example 3

### Extraction with HFO1234yf and Butane at 50° C.

The bottle was incubated in water at 50° C., with occasional shaking for five minutes. The contents of the bottle became homogeneous and opalescent. As the bottle cooled again, towards room temperature, the oil drops floated to the bottom of the bottle. The oil only floated to the top once more, as the temperature dropped to 17° C. (and below, in the refrigerator).

### Prophetic Example 4

Approximately 25 grams of commercial ground flax seed is introduced into a pre-weighed sealable 220 ml capacity PET bottle (extractor) and the bottle is re-weighed. The weight of raw material is calculated. The extractor is sealed, with an aerosol valve (to which has been attached a cellulose filter) and rubber “O” ring seal, a clamping yoke and a screw clamp. The entire assembly is re-weighed. Approximately 100 grams of HFO1234yf is introduced into the extractor bottle via the aerosol valve and the extractor, the seal, valve, filter, yoke and clamp are re-weighed and the exact quantity of introduced HFO1234yf is calculated.

The slurry so formed is shaken for ten minutes at room temperature (15 degrees Celsius). Another empty 220 ml capacity PET vessel (evaporator) equipped with another aerosol valve, brass connecting nipple, “O” ring seal, yoke and clamp (but without a cellulose filter) is weighed. The solution of oil in HFO1234yf contained within the extractor is transferred to the evaporator via the filter until no more liquid is observed to be forthcoming from it.

The drained extractor is weighed after this decantation. The retained HFO1234yf soaking the raw material is calculated. This facilitates the calculation of the yield of oil which is harvested and that which is retained and hence, the percentage of the solution which is removed to the evaporator and hence the total oil extracted from the raw material.

The solvent is entirely recovered (for re-cycling) by evaporation of the solution from the evaporator. The lid assembly is removed and the evaporator is allowed to come to an equilibrium (static) weight. The weight of the first oil is calculated from this weight, by deducting the weight of the evaporator assembly, when empty. This allows calculation of the first yield of oil (weight of oil/weight of raw material×100).

A further approximately 80 grams of HFO1234yf is introduced into the extractor which is again shaken. The exact weight of the further additional new solvent added, is calculated by deducting from this weight, the weight of the drained extractor, recorded previously. The entire operation is repeated. A total of three extractions, each using (mostly) new portions (as opposed to re-covered/re-cycled) of HFO1234yf are carried out on this sample of raw material and the oils are pooled.

### Prophetic Example 5

The procedures set out for Example 4 is repeated in a substantially identical fashion, save for the fact that the extractor bottle in each case is immersed in a water bath at 50° C. with shaking for ten minutes and the solution formed is quickly decanted into an evaporator. It will be expected that the extracted yield of a target compound using HFO1234yf alone at the increased temperature of 50° C. will be higher than the extraction performed at 17° C.

### Prophetic Example 6

A stock solution comprising HFO1234yf and butane is prepared in a PET 220 ml capacity reservoir bottle in the following manner. The reservoir, together with an aerosol valve (without a filter), “O” ring seal, yoke and clamp are assembled as in Example 1. This assembly is weighed. A quantity of butane is introduced via the valve and the extractor is weighed again. This enabled calculation of the weight of butane in the extractor. Into the extractor is then added HFO1234yf to form about a 5:1 solvent mixture, and the extractor is weighed again. This allows accurate calculation of the quantity of HFO1234yf added. A mixture comprising 144.41 grams of a mixture of 19.70% of butane in HFO1234yf is produced.

To a small quantity of raw material, contained in a new extractor bottle is added a portion of the solvent mixture, substantially as in Example 4. Three separate and sequential extractions of this raw material, with three portions of the solvent mixture are carried out. It will be expected that the extracted yield of a target compound using HFO1234yf and butane will be higher than the extraction performed using HFO1234yf alone.

### Prophetic Example 7

A substantially identical experiment as in Example 6, comprising the extraction of a portion of raw material with three lots of solvent mixture at 50° C. is carried out. It will be expected that the extracted yield of a target compound using HFO1234yf and butane at the increased temperature of 50° C. will be higher than the extraction performed at 17° C.

### Example 8

### Butane as Solvent for Rape Seed Extraction

Commercially available rape seed was ground in a high speed coffee grinder and sieved through a fine mesh screen to remove all un-broken seed, resulting in a fine meal. The fine meal (20.6 g) was then extracted using 100% liquid butane (31.79 g), as solvent. The slurry so formed was filtered and yielded a clear yellow solution weighing 23.79 grams. The solution contained 3.43 g of oil, and accordingly, 20.36 g of butane.

### Example 9

### HFO1234yf with Butane as Co-Solvent for Rape Seed Extraction

To the solution from Example 8 was added, incrementally, sequentially and at a temperature of 17° C., the following quantities of HFO1234yf:

| QUANTITY | AGGREGATE | % HFO w/w | SOLUTION |
|---|---|---|---|
| of HFO | ADDITION | in solution | APPEARANCE |
| 13.7 g | 13.7 g | 36.5% | CLEAR |
| 11.74 g | 25.44 g | 51.6% | CLEAR |
| 7.39 g | 32.83 g | 57.96% | SLIGHT HAZE |
| 10.02 g | 42.85 g | 64.3% | HAZE |
| 12.00 g | 54.85 g | 69.73% | MILKY |
| 11.91 g | 66.76 g | 73.72% | OIL SETTLES OUT |
| 9.3 g | 76.06 g | 76.17% | OIL SETTLES OUT |

Subsequent to concluding this experiment, the solvent was entirely removed from the oil. The bottle was weighed again and the contents were found to actually contain 3.43 grams of oil. The original mixture in this bottle, therefore, actually comprised 20.36 grams of butane (23.79-3.43).

A revision to the above figures must therefore be calculated as follows:

| | | Composition of mixture | | |
|---|---|---|---|---|
| QUANTITY | AGGREGATE | in solution | | SOLUTION |
| of HFO | ADDITION | HFO 1234yf | BUTANE | APPEARANCE |
| 13.7 g | 13.7 g | 40.2% | 59.8% | CLEAR |
| 11.74 g | 25.44 g | 55.5% | 44.5% | CLEAR |
| 7.39 g | 32.83 g | 61.7% | 38.3% | SLIGHT HAZE |
| 10.02 g | 42.85 g | 67.8% | 32.2% | HAZE |
| 12.00 g | 54.85 g | 72.9% | 27.1% | MILKY |
| 11.91 g | 66.76 g | 76.6% | 23.4% | OIL SETTLES OUT |
| 9.3 g | 76.06 g | 78.9% | 21.1% | OIL SETTLES OUT |

The HFO1234yf added to the butane solution from Example 8 results in significantly more target compound precipitating from the solvent mixture.

### Example 10

### Extraction with HFO1234yf and Butane at 50° C. for Rape Seed Extraction

The bottle was incubated in water at 50° C., with occasional shaking for five minutes. The contents of the bottle became homogeneous and opalescent. As the bottle cooled towards room temperature, the oil drops floated to the bottom of the bottle. The oil only floated to the top as the temperature dropped to 17° C. (and below, in the refrigerator).

We claim:

1. A process for the selective extraction of a target compound from a raw material comprising:
(i) contacting the raw material with 2,3,3,3-tetrafluoropropene (HFO1234yf) at a first temperature to extract the target compound into the HFO1234yf thereby forming a HFO1234yf solution, and
(ii) cooling the HFO1234yf solution to a second temperature to separate the target compound from the HFO1234yf.

2. The process according to claim 1, further comprising a co-solvent wherein the co-solvent comprises an alkane, alkene, fluorinated alkane or a fluorinated alkene.

3. The process according to claim 2, wherein the alkane or alkene comprises butane, propane, propylene, butylene, n-pentane, iso-pentane or cyclopentane.

4. The process according to claim 2, wherein the fluorinated alkane or fluorinated alkene comprises: a mixture of 1,1,1,3,3-pentafluoropropane and 1,1,1,2,2,3,4,5,5,5-decafluoropentane (HFC365HX); 1,1,1,2,2,3,4,5,5,5-decafluoropentane (HFC 43 10mee); or 1,1,1,2,2-pentafluoroethane (HFC 125).

5. The process according to claim 2, wherein the co-solvent comprises about 5% to about 50% by volume.

6. The process according to claim 5, wherein the co-solvent comprises about 15% to about 25% by volume.

7. The process according to claim 6, wherein the co-solvent comprises about 20% by volume.

8. The process according to claim 1, wherein the first temperature is between about 50° C. to about 70° C.

9. The process according to claim 8, wherein the first temperature is about 60° C.

10. The process according to claim 1, wherein the second temperature is less than about 30° C.

11. The process according to claim 10, wherein the second temperature is less than about 20° C.

12. The process according to claim 11, wherein the second temperature is less than about 15° C.

13. The process according to claim 1, wherein the second temperature is between about 0° C. to about 30° C.

14. The process according to claim 1, wherein the target compound is substantially in-volatile.

15. The process according to claim 1, wherein the target compound has a molecular weight of about 0 to about 3000 g/mol.

16. The process according to claim 1, wherein the target compound comprises a fixed oil or a mineral oil.

17. The process according to claim 1, wherein the raw material comprises a plant raw material, an animal raw material or a mineral raw material.

18. The process according to claim 17, wherein the raw material comprises roots, bark, leaves, nuts, oilseeds, palm kernel oil wastes, mineral oil shales or tar sands.

19. The process according to claim 17, wherein the raw material comprises canola, rapeseed, crambe, soybean, all mustard seeds, camelina, vernonia, borage, echium, hemp seed, flax/linseed, cotton seed, jatropha, saw palmetto berries, peanut, groundnut, oats, barley, marigold flowers and tomato skins, a carotenoid-containing feed stock, algae, micro algae, fungi, micro fungi, marine fungi, krill or other oil containing shellfish and their waste shells.

20. The process of claim 1, wherein the process further comprises cooling the HFO1234yf solution to precipitate the target compound from the HFO1234yf solution, resulting in cold depleted HFO1234yf, to be decanted for re-cycling and re-use.

21. The process of claim 20, further comprising, after cooling of the HFO1234yf solution, separating the precipitated target compound from the thereby depleted HFO1234yf solution.

22. The process of claim 21, further comprising, after separation of the precipitated target compound, heating the HFO1234yf.

23. The process according to claim 1, wherein the extracted raw material is a proteinaceous meal.

24. The process according to claim 23, wherein the proteinaceous meal is substantially non-denatured.
